(19) United States
(12) Patent Application Publication
(10) Pub. No.: US 2015/0060400 A1
(43) Pub. Date: Mar. 5, 2015

(54) POLISHING COMPOSITION

(71) Applicant: FUJIMI INCORPORATED, Kiyosu-shi, Aichi (JP)

(72) Inventor: Shuichi Tamada, Kiyosu-shi (JP)

(73) Assignee: FUJIMI INCORPORATED, Kiyosu-shi, Aichi (JP)

(21) Appl. No.: 14/394,953

(22) PCT Filed: Apr. 9, 2013
(86) PCT No.: PCT/JP2013/060719

§ 371 Date: Oct. 16, 2014

(30) Foreign Application Priority Data
Apr. 18, 2012 (JP) 2012-094584

(51) Int. Cl. C09G 1/02; B24B 1/00

(52) U.S. Cl. CPC C09G 1/02; B24B 1/00
USPC 216/38; 252/79.1

(57) ABSTRACT

The present invention provides a polishing composition that can suppress generation of bumps due to etching on a surface of an object to be polished having a germanium material-containing part during the polishing of the object.

The polishing composition of the present invention contains abrasive grains, an oxidant and a water-soluble polymer. The water-soluble polymer may be a water-soluble polymer such that 5,000 or more molecules are adsorbed per 1 μm² of the surface area of the abrasive grains. Alternatively, the water-soluble polymer may be a compound that reduces the water contact angle of the germanium material-containing part of the object to be polished after the object has been polished by using the polishing composition.

### TECHNICAL FIELD

The present invention relates to a polishing composition for use in polishing an object to be polished having a germanium material-containing part. The present invention also relates to a polishing method using the polishing composition, and a method for producing a substrate.

### BACKGROUND ART

As one of technologies for decreasing the power consumption and improving the performances (operation properties) of transistors, consideration of high mobility channel materials that enhance the mobility of carriers has been promoted. In these channels in which the carrier-transporting property has been improved, the drain current in an on-state can be increased, and thus the voltage of a power source can be decreased while obtaining a sufficient on-state current. This combination gives higher performances of MOSFETs (metal oxide semiconductor field-effect transistors) at a low electrical power.

As the high mobility channel materials, applications of Group III-V compounds, Group IV compounds, Ge (germanium), graphene composed only of C (carbon) and the like are expected. Currently, the formation of a Group III-V compound channel has a problem that a technique for increasing the crystallinity of the channel to successfully control and grow the shape has not been established, and thus Group IV compounds, which are introduced more easily than Group III-V compounds are, especially SiGe, Ge and the like, have been positively considered.

A channel using a high mobility material can be formed by polishing an object to be polished having a Group IV compound channel and/or a Ge channel (hereinafter also referred to as a germanium material-containing part, a Ge material-containing part, or a Ge material part) and a silicon material-containing part (hereinafter also referred to as a silicon material part). At this time, polishing of the Ge material part at a high polishing velocity, and prevention of generation of bumps such as dishing and erosion on the polished surface of the object to be polished are required. However, since polishing compositions that have been conventionally used for polishing Ge substrates such as the polishing composition described in Patent Literature 1 or Patent Literature 2 have been developed for use in Ge substrates, in the cases where these compositions are used for polishing an object to be polished having a Ge material part and a silicon material part, it is difficult to prevent the dishing of the Ge material part and the generation of the erosion of the silicon material part.

### CITATION LIST

### Patent Literatures

Patent Literature 1: JP 2010-130009 A
Patent Literature 2: JP 2010-519740 W (US 2011/0117740 (A1))

### SUMMARY OF INVENTION

Therefore, the objects of the present invention are to provide a polishing composition that can suppress the generation of bumps such as dishing and erosion on the surface of an object to be polished having a part containing a germanium material such as SiGe and Ge during the polishing of the object, and to provide a polishing method using the polishing composition and a method for producing a substrate.

In order to achieve the above-mentioned purpose, the first embodiment of the present invention provides a polishing composition used for polishing an object to be polished having a germanium material-containing part, which contains abrasive grains, an oxidant, and a water-soluble polymer.

The second embodiment of the present invention provides a method for polishing an object to be polished having a Ge material part by using the above-mentioned polishing composition of the first embodiment.

The third embodiment of the present invention provides method for producing a substrate having a Ge material-containing part, including a step of polishing by the above-mentioned polishing method of the second embodiment.

### DESCRIPTION OF EMBODIMENTS

An exemplary embodiment of the present invention will be explained below.

The polishing composition of the present exemplary embodiment is prepared by mixing abrasive grains, an oxidant and a water-soluble polymer with, for example, water. Therefore, the polishing composition contains the abrasive grains, oxidant and water-soluble polymer. When an object to be polished having a Ge material part is polished by using a polishing composition having such constitution, the generation of bumps such as dishing and erosion on the surface of the object to be polished can be suppressed.

This polishing composition is used for polishing of an object to be polished having a Ge material part, specifically for the production of a substrate by polishing the object to be polished. The object to be polished may further have a silicon material part. Examples of the Ge material include Ge (germanium) and SiGe (silicon germanium). Furthermore, examples of the silicon material include polysilicons, silicon oxides and silicon nitrides.

### (Abrasive Grains)

The abrasive grains contained in the polishing composition may be either of inorganic grains and organic grains. Specific examples of the inorganic grains include grains formed of metal oxides such as silica, alumina, ceria and titania. Specific examples of the organic grains include polymethyl methacrylate (PMMA) grains. Among these, silica grains are preferable, and colloidal silica is especially preferable. These abrasive grains can be used singly or by mixing two or more kinds.

The content of the abrasive grains in the polishing composition is preferably 0.01% by weight or more, more preferably 0.05% by weight or more, further preferably 0.1% by weight or more. As the content of the abrasive grains increases, the velocity of the polishing of the Ge material part by the polishing composition is improved more.

Furthermore, the content of the abrasive grains in the polishing composition is preferably 20% by weight or less, more preferably 17% by weight or less, further preferably 15% by weight or less. As the content of the abrasive grains decreases, the costs of the materials for the polishing composition can be suppressed more, and the flocculation of the abrasive grains becomes harder to occur.

The average primary grain size of the abrasive grains is preferably 5 nm or more, more preferably 7 nm or more, and further preferably 10 nm or more. As the average primary grain size of the abrasive grains increases, the velocity of the polishing of the Ge material part by the polishing composition is improved more. The value of the average primary grain size of the abrasive grains can calculated based on, for example, the specific surface area of the abrasive grains measured by a BET method.

Furthermore, the average primary grain size of the abrasive grains is preferably 150 nm or less, more preferably 110 nm or less, further preferably 100 nm or less. As the average primary grain size of the abrasive grains decreases, it becomes easier to obtain a polished surface with lesser scratches by polishing the object to be polished by using the polishing composition.

The average secondary grain size of the abrasive grains is preferably 300 nm or less, more preferably 270 nm or less, further preferably 250 nm or less. As the average secondary grain size of the abrasive grains decreases, it becomes easier to obtain a polished surface with lesser scratches by polishing the object to be polished by using the polishing composition. The value of the average secondary grain size of the abrasive grains can be measured by, for example, a laser light scattering method.

The abrasive grains may undergo surface modification. General colloidal silica has a zeta potential value that is close to zero under an acidic condition, and thus the silica grains do not act in electrical and repulsive manners with one another, and easily flocculate under an acidic condition. On the other hand, abrasive grains that have undergone surface modification so that the zeta potential would have a relatively high positive or negative value even under an acidic condition strongly act in a repulsive manner with one another and finely disperse even under an acidic condition, and consequently improve the storage stability of the polishing composition. Such surface-modified abrasive grains can be obtained by, for example, doping the surfaces of the abrasive grains with a metal such as aluminum, titanium or zirconium, or an oxide thereof, by mixing the metal or oxide with the abrasive grains.

Alternatively, the surface-modified abrasive grains in the polishing composition may be silica on which an organic acid is fixed. Specifically, colloidal silica on which an organic acid is fixed is preferable. The organic acid is fixed on the colloidal silica by chemically binding the functional group of the organic acid on the surface of the colloidal silica. The fixation of the organic acid on the silica cannot be achieved by only allowing the coexisting of the colloidal silica and the organic acid. If the fixation of sulfonic acid, which is one of organic acids, on the colloidal silica is intended, the fixation can be conducted by, for example, the method described in “Sulfonic acid-functionalized silica through quantitative oxidation of thiol groups”, Chem. Commun. 246-247 (2003). Specifically, a colloidal silica with sulfonic acid fixed on the surface thereof can be obtained by coupling a silane coupling agent having a thiol group such as 3-mercaptopropyltrimethoxysilane with colloidal silica, and oxidizing the thiol groups with hydrogen peroxide. Alternatively, if a carboxylic acid is to be fixed on colloidal silica, the fixation can be conducted by, for example, the method describe in “Novel Silane Coupling Agents Containing a Photolabile 2-Nitrobenzyl Ester for Introduction of a Carboxy Group on the Surface of Silica Gel”, Chemistry Letters, 3, 228-229 (2000). Specifically, a colloidal silica with a carboxylic acid fixed on the surface thereof can be obtained by coupling a silane coupling agent containing a photoreactive 2-nitrobenzyl ester with colloidal silica, and irradiating the colloidal silica with light.

### (Oxidant)

Although the kind of the oxidant contained in the polishing composition is not especially limited, it is preferable that the oxidant has a standard electrode potential of 0.3 V or more. In the case where an oxidant having a standard electrode potential of 0.3 V or more is used, it is advantageous since the velocities of the polishing of the Ge material part and silicon material part by the polishing composition are improved more than those in the case where an oxidant having a standard electrode potential of lower than 0.3 V is used. Specific examples of the oxidant having a standard electrode potential of 0.3 V or more include hydrogen peroxide, sodium peroxide, barium peroxide, organic oxidants, ozone water, silver(II) salts, iron(III) salts, and permanganic acid, chromic acid, dichromic acid, peroxodisulfuric acid, peroxophosphoric acid, peroxosulfuric acid, peroxoboric acid, performic acid, peracetic acid, perbenzoic acid, perphthalic acid, hypochlorous acid, hypobromous acid, hypoiodous acid, chloric acid, chlorous acid, perchloric acid, bromic acid, iodic acid, periodic acid, sulfuric acid, persulfuric acid, citric acid and dichloroisocyanuric acid, and salts thereof. These oxidants may be used singly or by mixing two or more kinds.

Among these, hydrogen peroxide, ammonium persulfate, periodic acid, hypochlorous acid and sodium dichloroisocyanuric acid are preferable since they significantly improve the velocities of the polishing of the Ge material part and silicon material part by the polishing composition.

The standard electrode potential is represented by the following numerical formula 1 when all chemical species that are involved in an oxidation reaction are in standard states.

[Math. 1]

E0=−ΔG0/nF=(RT/nF)ln K Mathematical Formula 1

In the formula, E0 is a standard electrode potential, ΔG0 is the change in standard Gibbs energy in the oxidation reaction, K is the equilibrium constant thereof, F is a Faraday's constant, T is an absolute temperature, and n is the number of electrons that are involved in the oxidation reaction. As is apparent from the above-mentioned Mathematical Formula 1, since the standard electrode potential varies depending on the temperature, the standard electrode potential at 25° C. is adopted in the present specification. The standard electrode potential of the aqueous solution system is described in, for example, Chemistry Handbook Revised Version 4 (Basic Edition) II, pp 464-468 (edited by The Chemical Society of Japan) and the like.

The content of the oxidant in the polishing composition is preferably 0.01 mol/L or more, more preferably 0.1 mol/L or more. As the content of the oxidant increases, the velocity of the polishing of the Ge material part by the polishing composition is improved.

Furthermore, the content of the oxidant in the polishing composition is preferably 100 mol/L or less, more preferably 50 mol/L or less. As the content of the oxidant decreases, the costs for the materials of the polishing composition can be suppressed, and the burden of the treatment of the polishing composition after use in polishing, i.e., waste water treatment, can be decreased.

### (Water-Soluble Polymer)

The kind of the water-soluble polymer contained in the polishing composition is not especially limited, and a water-soluble polymer of such a kind that 5,000 or more molecules are adsorbed per 1 μm² of the surface area of the abrasive grains such as a nonionic compound having a polyoxyalkylene chain can be preferably used. Specific examples of the nonionic compound having a polyoxyalkylene chain include polyethylene glycols, polypropylene glycols, polyoxyethylene (hereinafter referred to as POE) alkylene diglyceryl ethers, POE alkyl ethers, POE sorbitan aliphatic acid esters, POE alkyl phenyl ethers, POE glycol aliphatic acid esters, POE hexytan aliphatic acid esters, POE polypropylene alkyl ethers, and block/random copolymers of polyoxypropylene/polyoxyethylene. In the case where such water-soluble polymer is used, the water-soluble polymer in a predetermined amount or more is adsorbed on the surfaces of the abrasive grains through the polyoxyalkylene chain, whereby the surface property of the abrasive grains is changed, and thus the generation of dishing and erosion on the surface of the object to be polished can be suppressed.

With respect to the above-mentioned water-soluble polymer, in order to increase the solubility in water, alkaline substances such as sodium hydroxide, potassium hydroxide, ammonia and tetramethylammonium hydroxide (TMAH), or salts neutralized with acidic substances such as hydrochloric acid, nitric acid and sulfuric acid can be used. In the case where the base of the object to be polished is a silicon substrate for a semiconductor integrated circuit, or the like, in order to prevent pollution by alkali metals, alkali earth metals, halides and the like, it is especially desirable to use acids being free from halogens such as nitric acid and sulfuric acid, or tetramethylammonium hydroxide or ammonia, which is free from alkali metals and alkali earth metals. However, this does not apply to the case where the base is a glass substrate or the like. Furthermore, the water-soluble polymer may be a copolymer of those water-soluble polymers. In the case where such water-soluble polymer is used, the water-soluble polymer in a predetermined amount or more is adsorbed on the surfaces of the abrasive grains and the surface property of the abrasive grains is changed, and thus generation of dishing and erosion on the surface of the object to be polished can be suppressed.

Alternatively, the water-soluble polymer contained in the polishing composition may be a water-soluble polymer having an amine value of 10 mg KOH/g or more per 1 g of the solid content of the water-soluble polymer. Since the water-soluble polymer having an amine value of 10 mg KOH/g or more contained in the polishing composition shows cationicity, the water-soluble polymer in a predetermined amount or more is adsorbed on the surfaces of the abrasive grains and the surface property of the abrasive grains is changed. Consequently, generation of dishing and erosion on the surface of the object to be polished can be suppressed.

The amine value is an index that shows the intensity of cationicity, and the adsorbability on the abrasive grains increases more at a higher value. In the present exemplary embodiment, the water-soluble polymer contained in the polishing composition is preferably a water-soluble polymer having an amine value of 10 mg KOH/g or more. When the amine value becomes lower than 10 mg KOH/g, the dishing-suppressing effect may decrease. From the viewpoint of improvement of the dishing-suppressing effect, the amine value of the water-soluble polymer is preferably 30 mg KOH/g or more, more preferably 50 mg KOH/g or more, further preferably 100 mg KOH/g or more, and even more preferably 150 mg KOH/g or more.

The amine value of the water-soluble polymer contained in the polishing composition is preferably 3,000 mg KOH/g or less, more preferably 2,000 mg KOH/g or less, and further preferably 1,000 mg KOH/g or less. A lower amine value is more preferable since the dispersion stability of the abrasive grains is improved.

The amine value of the water-soluble polymer is the number of mg of potassium hydroxide (KOH) in an amount equivalent to the amount of hydrochloric acid that is necessary for neutralizing the primary amine, secondary amine and tertiary amine contained in the water-soluble polymer in a unit weight. The amine value of the water-soluble polymer can be measured, for example, as follows. Firstly, water is added to the water-soluble polymer with a solid content amount of 1.0 g so as to be 100 g. Secondly, a 0.1 N aqueous sodium hydroxide solution is added thereto, whereby a sample in which the pH has been adjusted to 11.0 is prepared. The sample is then titrated with 0.5 N hydrochloric acid, and the amount of the hydrochloric acid that is added dropwise until the pH becomes 10 and the amount of the hydrochloric acid that is added dropwise until the pH becomes 5 are measured. Thereafter, the amine value can be obtained from the following numerical formula 2.

[Math. 2]

Amine value=((V5−V10)×F×0.5×56.1)/S Mathematical Formula 2

Provided that

V10: the amount of 0.5 N hydrochloric acid dropped until the pH becomes 10 (ml)
V5: the amount of 0.5 N hydrochloric acid dropped until the pH becomes 5 (ml)
F: the factor of the 0.5 N hydrochloric acid used in the titration
S: the solid content of the water-soluble polymer (g)
0.5: the normality of the hydrochloric acid used in the titration
56.1: the molecular weight of potassium hydroxide

Examples of the water-soluble polymer having an amine value of 10 mg KOH/g or more include polyalkyleneimines such as polyethyleneimine and polypropyleneimine, allylamine polymers, amine methacrylate polymers, polyamide-polyamine copolymers such as succinic acid-diethylenetriamine copolymers, glutamic acid-diethylenetriamine copolymers and adipic acid-diethylenetriamine copolymers, polyhydroxypropyldimethylammonium, poly{(2-hydroxypropyl)chloride}dimethylammonium, polyaminealkyloxide polymers, dicyandiamidepolyalkylene copolymers such as dicyandiamide-diethylenetriamine copolymers and 1,3-propanediamine-dicyandiamine condensates, dicyandiamideformalin polymers such as diethylenetriamine-formalin copolymers, polyamidealkyloxide polymers, vinylformamide-vinylamine polymers, polyvinylamidines, diallylamines and copolymers of diallylamines and organic acids, cationic polymers such as N-vinylformamide-vinylamine copolymers, polyvinylimidazolines and polyvinylpyridines, and the like, copolymers of cationic polymers and polyvinyl alcohols or polyacrylamide copolymers, polyvinyl alcohols having cationic functional groups (cationized polyvinyl alcohols), polyacrylic acids, polyacrylamides, dimethylamine-ethylenediamine-epichlorohydrin copolymers, polydiallyldimethylammonium chlorides, and modified polymers of the above mentioned these water-soluble polymers such as urea-modified polymers, carboxymethyl-modified polymers and epihalohydrin-modified polymers.

With respect to the above-mentioned water-soluble polymers, in order to increase the solubility in water, alkaline substances such as sodium hydroxide, potassium hydroxide, ammonia and tetramethylammonium hydroxide (TMAH), or salts neutralized with acidic substances such as hydrochloric acid, nitric acid and sulfuric acid may also be used. In the case where the base of the object to be polished is a silicon substrate for a semiconductor integrated circuit, or the like, in order to prevent pollution due to alkali metals, alkali earth metals, halides and the like, it is especially desirable to use acids being free from halogens such as nitric acid and sulfuric acid, or tetramethylammonium hydroxide or ammonia, which is free from alkali metals and alkali earth metals. However, this does not apply to the case where the base is a glass substrate or the like. Furthermore, in order to improve the action on the surface of the substrate, one kind or two or more kinds of monomer (s) that is/are different from the monomer constituting the water-soluble polymer may be introduced in these water-soluble polymers. In the case where such water-soluble polymer is used, the water-soluble polymer in a predetermined amount or more is adsorbed on the surfaces of the abrasive grains and the surface property of the abrasive grains is changed. Consequently, generation of dishing and erosion on the surface of the object to be polished can be suppressed.

Alternatively, a water-soluble polymer having a hydrophilic group such as a hydroxyl group, a carboxy group, an aminogroup and an ether group can also be used. In the case where such water-soluble polymer is used, the water-soluble polymer in the polising composition is adsorbed on the surface of the Ge material part having hydrophobicity, whereby the wettability of the surface of the object to be polished is improved. Consequently, generation of bumps such as dishing and erosion on the surface of the object to be polished can be suppressed. Examples of such water-soluble polymer include polyvinyl alcohols, ethylene-polyvinyl alcohol copolymers and the like.

The number of the hydrophilic groups possessed by the water-soluble polymer is preferably three or more, more preferably five or more, further preferably ten or more per one molecule. The larger number of the hydrophilic groups possessed by the water-soluble polymer is, the more the hydrophilic effect on the Ge material part increases, whereby generation of bumps such as dishing and erosion can further be suppressed.

It is preferable that the above-mentioned water-soluble polymer is selected from compounds of such a kind that the water contact angle of the Ge material part after the object to be polished has been polished by using the polishing composition becomes smaller than the water contact angle of the Ge material part after the same object to be polished has been polished under the same polishing conditions by using another polishing composition having the same composition as that of this polishing composition except for the water-soluble polymer. Such compounds are preferable since they further improve the wettability of the surface of the object to be polished. Furthermore, the water contact angle is preferably 57° or less, more preferably 50° or less, further preferably 45° or less. The conditions for the polishing of the object to be polished in the measurement of the water contact angle include the conditions described in the following Table 5. Specific examples of such water-soluble polymer include alginic acid, pectinic acid, carboxymethyl cellulose, hydroxyethyl cellulose, starch, agar, curdlan and pullulan, which are polysaccharides, polyethylene glycol, polyglycerin, pentanol, polypropylene glycol and polyvinyl alcohol, which are alcohol compounds (of these, polyethylene glycol, polyglycerin and polypropylene glycol are alcohol compounds and are also polyethers), POE alkylene diglyceryl ethers, POE alkyl ethers and monooleic acid POE (6) sorbitan, which are nonionic compounds each having a polyoxyalkylene chain, polyaspartic acid, polyglutamic acid, polylysine, polymalic acid, polymethacrylic acid, ammonium polymethacrylate, sodium polymethacrylate, polymaleic acid, polyitaconic acid, polyfumaric acid, poly(p-styrenecarboxylic acid), polyacrylic acid, polyacrylamide, aminopolyacrylamide, polymethyl acrylate, polyethyl acrylate, ammonium polyacrylate, sodium polyacrylate, polyamic acid, ammonium polyamidate, sodium polyamidate, polyglyoxyl acid, polycarboxylic acid amides, polycarboxylic acid esters and polycarboxylic acid salts, which are polycarboxylic acids or salts thereof.

The content of the water-soluble polymer in the polishing composition is preferably 10 weight ppm or more, more preferably 50 weight ppm or more, and further preferably 100 weight ppm or more. As the content of the water-soluble polymer increases, further suppression of generation of dishing and erosion can be expected.

Furthermore, the content of the water-soluble polymer in the polishing composition is preferably 100,000 weight ppm or less, more preferably 50,000 weight ppm or less, and further preferably 10,000 weight ppm or less. As the content in the water-soluble polymer decreases, the flocculation of the abrasive grains in the polishing composition becomes harder to occur, whereby the storage stability of the polishing composition is improved.

The weight average molecular weight of the water-soluble polymer is preferably 100 or more, more preferably 300 or more. As the weight average molecular weight of the water-soluble polymer increases, further suppression of generation of dishing and erosion can be expected.

The weight average molecular weight of the water-soluble polymer is preferably 500,000 or less, more preferably 300,000 or less. As the weight average molecular weight of the water-soluble polymer decreases, the flocculation of the abrasive grains in the polishing composition becomes harder to occur, whereby the storage stability of the polishing composition is improved. The weight average molecular weight of the water-soluble polymer can be measured by gel permeation chromatography (GPC).

The polishing composition of the present exemplary embodiment may contain an anionic surfactant represented by the chemical formula: R1-X1-Y1 as the water-soluble polymer. In the formula 1, R1 represents an alkyl group, an alkylphenyl group or an alkenyl group, X1 represents a polyoxyethylene group, a polyoxypropylene group or a poly(oxyethylene-oxypropylene) group, and Y1 represents a SO₃M1 group, a SO₄M1 group, a CO₂M1 group or a PO₃M1₂ group. M1 in the SO₃M1 group, SO₄M1 group, CO₂M1 group, and PO₃M1₂ group represents a counter ion. Examples of the counter ion include, but are not limited to, hydrogen ion, ammonium cation, cations of amines, and alkali metal cations such as lithium cation, sodium cation and potassium cation. In the case where such anionic surfactant is used as the water-soluble polymer, the anionic surfactant is electrically adsorbed by the Ge material part of the object to be polished to forma protective film, whereby the affinity between the surface of the Ge material part and the abrasive grains is decreased. Consequently, generation of dishing on the surface of the object to be polished can be suppressed.

The above-mentioned water-soluble polymers can be used singly or by mixing two or more kinds.

According to the present exemplary embodiment, the following operation and effect can be obtained.

In the polishing composition of the present exemplary embodiment, a water-soluble polymer that interacts with a Ge material part of an object to be polished is used so as to suppress generation of bumps such as dishing and erosion on the surface of the object to be polished. Therefore, the polishing composition of the present exemplary embodiment is preferably used for polishing an object to be polished having a Ge material part.

The above-mentioned exemplary embodiment may also be modified as follows.
The polishing composition of the above-mentioned exemplary embodiment may contain water as a dispersion medium or solvent for dispersing or dissolving the respective components. From the viewpoint of suppression of inhibition of the functions of the other components, water that is free from impurities as possible is preferable, and pure water or ultrapure water that is obtained by removing impurity ions by an ion exchanging resin, and subsequently removing contaminants through a filter, or distilled water is specifically preferable.
The polishing composition of the above-mentioned exemplary embodiment may further contain known additives such as an antiseptic agent as necessary.
The polishing composition of the above-mentioned exemplary embodiment may be of a single-liquid type, or a multi-liquid type such as a two-liquid type.
The polishing composition of the above-mentioned exemplary embodiment may also be prepared by diluting a neat liquid of the polishing composition with water.

### [Polishing Method and Method for Producing Substrate]

As mentioned above, the polishing composition of the present invention is preferably used for polishing an object to be polished having a Ge material-containing part. Therefore, the present invention provides a method for polishing including polishing an object to be polished having a Ge material-containing part with the polishing composition of the present invention. Furthermore, the present invention provides a method for producing a substrate having a Ge material-containing part, including a step of polishing by the above-mentioned polishing method.

As an apparatus for the polishing, a general polishing apparatus having a polishing plate to which a holder that is configured to retain a substrate having an object to be polished, and the like, a motor whose rotation number can be changed, and the like are attached, to which a polishing pad (polishing cloth) can be adhered, can be used.

As the above-mentioned polishing pad, general nonwoven fabrics, polyurethanes, and porous fluorine resins and the like can be used without specific limitation. It is preferable that such grooves that a polisher liquid is pooled therein are formed on the polishing pad by grooving.

The conditions for the polishing are also not especially limited, and for example, the rotation velocity of the polishing plate is preferably from 10 to 500 rpm, and the pressure applied to the substrate having the object to be polished (polishing pressure) is preferably form 35 to 700 g/cm² (0.5 to 10 psi). The method for feeding the polishing composition to the polishing pad is also not especially limited, and for example, a method for continuously feeding by a pump or the like is adopted. Although the amount of this feeding is not limited, it is preferable that the surface of the polishing pad is always covered with the polishing composition of the present invention.

After the polishing is completed, the substrate is washed in running water, and dried by flicking the water droplets attached onto the substrate from the substrate by a spin drier or the like, whereby a substrate having a germanium material-containing part can be obtained.

### EXAMPLES

Next, Examples and Comparative Examples of the present invention will be explained.

The polishing compositions of Examples 1 to 25 were each prepared by mixing colloidal silica, an oxidant and a water-soluble polymer with water. Furthermore, the polishing composition of Comparative Example 1 was prepared by mixing colloidal silica and an oxidant with water. The details of the components of the respective polishing compositions are shown in Table 1 to Table 3.

TABLE 1

| | Colloidal silica | | | Oxidant | | | | | | |
|---|---|---|---|---|---|---|---|---|---|---|
| | Primary | | | | Standard | | | | | |
| | grain | Secondary | | | electrode | | Water-soluble polymer | | | |
| | size | grain size | Content | | potential | Content | | Molecular | Content | Presence or absence of |
| | (nm) | (nm) | (wt %) | Kind | (V) | (mol/L) | Kind | weight | (wt ppm) | polyoxyalkylene chain |
| Example 1 | 33.3 | 64.3 | 1 | H₂O₂ | 1.7 | 0.2 | Polyethylene | 400 | 5000 | Present |
| | | | | | | | glycol | | | |
| Example 2 | 33.3 | 64.3 | 1 | H₂O₂ | 1.7 | 0.2 | Polyethylene | 1000 | 5000 | Present |
| | | | | | | | glycol | | | |
| Example 3 | 33.3 | 64.3 | 1 | H₂O₂ | 1.7 | 0.2 | Polypropylene | 400 | 5000 | Present |
| | | | | | | | glycol | | | |
| Example 4 | 33.3 | 64.3 | 1 | H₂O₂ | 1.7 | 0.2 | Polypropylene | 1000 | 5000 | Present |
| | | | | | | | glycol | | | |
| Example 5 | 33.3 | 64.3 | 1 | H₂O₂ | 1.7 | 0.2 | POE alkylene | 400 | 200 | Present |
| | | | | | | | diglyceryl ether | | | |
| Example 6 | 33.3 | 64.3 | 1 | H₂O₂ | 1.7 | 0.2 | POE alkyl ether | 350 | 200 | Present |
| Example 7 | 33.3 | 64.3 | 1 | H₂O₂ | 1.7 | 0.2 | POE (6) sorbitan | 500 | 200 | Present |
| | | | | | | | monooleate | | | |
| Example 8 | 33.3 | 64.3 | 1 | H₂O₂ | 1.7 | 0.2 | Pullulan | 200000 | 5000 | Absent |
| Example 9 | 33.3 | 64.3 | 1 | H₂O₂ | 1.7 | 0.2 | Polyglycerin | 310 | 5000 | Absent |
| Example | 33.3 | 64.3 | 1 | H₂O₂ | 1.7 | 0.2 | Polyglycerin | 750 | 5000 | Absent |
| 10 | | | | | | | | | | |
| Example | 33.3 | 64.3 | 1 | H₂O₂ | 1.7 | 0.2 | Pentanol | 88 | 5000 | Absent |
| 11 | | | | | | | | | | |
| Example | 33.3 | 64.3 | 1 | H₂O₂ | 1.7 | 0.2 | Polyvinyl | 22000 | 5000 | Absent |
| 12 | | | | | | | alcohol | | | |

TABLE 2

| | Colloidal silica | | | Oxidant | | | Water-soluble polymer | | | |
|---|---|---|---|---|---|---|---|---|---|---|
| | Primary | Secondary | | | Standard | | | | | Amine |
| | grain | grain | | | electrode | | | | | value |
| | size | size | Content | | potential | Content | | Molecular | Content | (mgKOH/ |
| | (nm) | (nm) | (wt %) | Kind | (V) | (mol/L) | Kind | weight | (wt ppm) | gsolid) |
| Example 13 | 33.3 | 64.3 | 1 | H₂O₂ | 1.7 | 0.2 | Polyethyleneimine | 1800 | 2500 | 950 |
| Example 14 | 33.3 | 64.3 | 1 | H₂O₂ | 1.7 | 0.2 | Polyethyleneimine | 10000 | 2500 | 640 |
| Example 15 | 33.3 | 64.3 | 1 | H₂O₂ | 1.7 | 0.2 | Polydiallyldimethylammonium | 9000 | 2500 | 250 |
| | | | | | | | chloride | | | |
| Example 16 | 33.3 | 64.3 | 1 | H₂O₂ | 1.7 | 0.2 | Polydiallyldimethylammonium | 300000 | 1000 | 50 |
| | | | | | | | chloride | | | |
| Example 17 | 33.3 | 64.3 | 1 | H₂O₂ | 1.7 | 0.2 | Polyamidepolyamine (succinic | 500 | 1000 | 810 |
| | | | | | | | acid-triethylenetetramine | | | |
| | | | | | | | copolymer) | | | |
| Example 18 | 33.3 | 64.3 | 1 | H₂O₂ | 1.7 | 0.2 | Polyamidepolyamine (glutamic | 4000 | 1000 | 340 |
| | | | | | | | acid-triethylenetetramine | | | |
| | | | | | | | copolymer) | | | |
| Example 19 | 33.3 | 64.3 | 1 | H₂O₂ | 1.7 | 0.2 | Polyamidepolyamine (adipic | 5500 | 1000 | 280 |
| | | | | | | | acid-triethylenetetramine | | | |
| | | | | | | | copolymer) | | | |
| Example 20 | 33.3 | 64.3 | 1 | H₂O₂ | 1.7 | 0.2 | Dicyandiamide-diethylenetriamine | 10000 | 1000 | 610 |
| | | | | | | | copolymer | | | |
| Example 21 | 33.3 | 64.3 | 1 | H₂O₂ | 1.7 | 0.2 | Poly{(2-hydroxypropyl)- | 5000 | 2500 | 230 |
| | | | | | | | chloride}dimethyammonium | | | |
| Example 22 | 33.3 | 64.3 | 1 | H₂O₂ | 1.7 | 0.2 | Dimethylamine-ethylenediamine- | 5000 | 2500 | 300 |
| | | | | | | | epichlorohydrin copolymer | | | |

TABLE 3

| | Colloidal silica | | | | | | | | | |
|---|---|---|---|---|---|---|---|---|---|---|
| | Primary | | | Oxidant | | | | | | |
| | grain | Secondary | | | Standard | | Water-soluble polymer | | | |
| | size | grain size | Content | | electrode | Content | | Molecular | Content | Amine value |
| | (nm) | (nm) | (wt %) | Kind | potential (V) | (mol/L) | Kind | weight | (wt ppm) | (mgKOH/gsolid) |
| Example 23 | 33.3 | 64.3 | 1 | H₂O₂ | 1.7 | 0.2 | Polyacrylamide copolymer | 200000 | 250 | 250 |
| Example 24 | 33.3 | 64.3 | 1 | H₂O₂ | 1.7 | 0.2 | Polyvinylamidine | 25000 | 2500 | 450 |
| Example 25 | 33.3 | 64.3 | 1 | H₂O₂ | 1.7 | 0.2 | Cationized polyvinyl | 20000 | 2500 | 20 |
| | | | | | | | alcohol | | | |
| Comparative | 33.3 | 64.3 | 1 | H₂O₂ | 1.7 | 0.2 | — | — | — | — |
| Example 1 | | | | | | | | | | |

With respect to the respective polishing compositions of Examples 1 to 12, the number of molecules of the water-soluble polymer adsorbed per a unit surface area of the colloidal silica was measured. Namely, each polishing composition was left for a day under an environment of a temperature at 25° C., and centrifuged at a rotation velocity of 20,000 rpm for two hours to collect the supernatant. The total organic carbon amount in the collected supernatant was measured by using an organic carbon measurement apparatus of a combustion catalytic oxidation system. Furthermore, compositions having similar compositions to those of the respective polishing compositions except for colloidal silica were separately prepared, and each composition was left for a day under an environment of a temperature at 25° C., and the total organic carbon amount in the composition was measured in a similar manner by using an organic carbon measurement apparatus of a combustion catalytic oxidation system. Furthermore, the total organic carbon amount in the supernatant of the corresponding polishing composition was subtracted from this total organic carbon amount, whereby the total adsorption amount of the water-soluble polymer with respect to the colloidal silica in the polishing composition was calculated. The number of the molecules of the water-soluble polymer adsorbed per a unit surface area of the colloidal silica was able to be calculated from the adsorption amount calculated by this way, based on the surface area of the colloidal silica and the molecular weight of the water-soluble polymer. The result is shown in the column of “Number of adsorbed molecules per 1 μm² of colloidal silica” in the following Table 4.

Using the respective polishing compositions of Examples 1 to 25 and Comparative Example 1, silicon germanium pattern wafers and germanium pattern wafers were polished under the conditions described in Table 5, and the obtained values of dishing are respectively shown in the columns of “Dishing of Ge” and “Dishing of SiGe” in Table 4. The dishing was obtained by a bump measurement machine. Each polishing time was set as a suitable time until a pattern of Ge or SiGe and TEOS was exposed.

Using the respective polishing compositions of Examples 1 to 25 and Comparative Example 1, silicon germanium pattern wafers and germanium pattern wafers were polished under the conditions described in Table 5, and the obtained results of the evaluation of erosion are respectively shown in the columns of “Erosion of Ge/TEOS” and “Erosion of SiGe/TEOS” in Table 4. The erosion was obtained by measuring the amount of progress of erosion for each pattern wafer after the polishing, by using an atomic force microscope at the boundary area between Ge or SiGe and TEOS. The case where the amount of progress of erosion was 25 Å or less was evaluated as “⊙”, the case where the amount is more than 25 Å and less than 100 Å was evaluated as “∘”, and the case where the amount is 100 Å or more was evaluated as “x”. Each polishing time was set as a suitable time until a pattern of Ge or SiGe and TEOS was exposed.

The silicon germanium pattern wafers and the germanium pattern wafers after the polishing by using the respective polishing compositions of Examples 1 to 12 and Comparative Example 1 were each rinsed by pure water and dried by blowing dried air, and the water contact angle was measured by a θ/2 method using a contact angle evaluation apparatus. The results are shown in the column of “Water contact angle” in Table 4. Comparative Example 1 was used as another composition having a composition except for a water-soluble polymer.

TABLE 4

| | Number of | | | | | |
|---|---|---|---|---|---|---|
| | adsorbed | | | | | |
| | molecules per 1 μm² | Water contact | | | | |
| | of colloidal | angle | Dishing of Ge | Erosion of | Dishing of SiGe | Erosion of |
| | silica | (degree) | (Å) | Ge/TEOS | (Å) | SiGe/TEOS |
| Example 1 | 7425 | 52.2 | 370 | ◯ | 280 | ◯ |
| Example 2 | 7477 | 50.4 | 540 | ◯ | 410 | ◯ |
| Example 3 | 2532 | 49.8 | 360 | ◯ | 270 | ◯ |
| Example 4 | 15926 | 50.2 | 330 | ◯ | 250 | ◯ |
| Example 5 | 65756 | 50.8 | 320 | ◯ | 240 | ◯ |
| Example 6 | 27368 | 42.9 | 250 | ⊙ | 190 | ⊙ |
| Example 7 | 48426 | 53.7 | 210 | ◯ | 160 | ◯ |
| Example 8 | 0 | 19.0 | 490 | ⊙ | 370 | ⊙ |
| Example 9 | 0 | 43.8 | 530 | ⊙ | 400 | ⊙ |
| Example 10 | 0 | 41.3 | 450 | ⊙ | 340 | ⊙ |
| Example 11 | 0 | 43.2 | 600 | ⊙ | 450 | ⊙ |
| Example 12 | 0 | 31.0 | 460 | ⊙ | 350 | ⊙ |
| Example 13 | — | — | 390 | ⊙ | 270 | ⊙ |
| Example 14 | — | — | 420 | ⊙ | 320 | ⊙ |
| Example 15 | — | — | 370 | ⊙ | 280 | ⊙ |
| Example 16 | — | — | 470 | ◯ | 320 | ◯ |
| Example 17 | — | — | 220 | ⊙ | 240 | ⊙ |
| Example 18 | — | — | 310 | ⊙ | 310 | ⊙ |
| Example 19 | — | — | 350 | ⊙ | 280 | ⊙ |
| Example 20 | — | — | 480 | ⊙ | 330 | ⊙ |
| Example 21 | — | — | 360 | ⊙ | 270 | ⊙ |
| Example 22 | — | — | 480 | ⊙ | 330 | ⊙ |
| Example 23 | — | — | 460 | ⊙ | 320 | ⊙ |
| Example 24 | — | — | 380 | ⊙ | 330 | ⊙ |
| Example 25 | — | — | 320 | ◯ | 290 | ◯ |
| Comparative | — | 56.6 | 3000 | X | 3000 | X |
| Example 1 | | | | | | |

TABLE 5

Polishing apparatus: Single-sided CMP polishing machine
Polishing pad: polyurethane pad (IC-1010 manufactured by Rodel Inc.)
Polishing pressure: 100 g/cm² (1.42 psi)
Number of rotation of plate: 50 rpm
Feeding velocity of polishing composition: 100 mL/min

As shown in the above-mentioned Table 4, it was recognized that, in the cases where the polishing compositions of Examples 1 to 25, which contained water-soluble polymers, were used, significantly excellent effects were exerted in the suppression of bumps in the silicon-germanium pattern wafers and germanium patterns, as compared to the polishing composition of Comparative Example 1, which did not satisfy the condition of the present invention, i.e., did not contain a water-soluble polymer.

The present application is based on Japanese Patent Application No. 2012-094584 filed on Apr. 18, 2012, and the content of the disclosure thereof is herein incorporated by reference in its entirety.

1. A polishing composition used for polishing an object to be polished having a germanium material-containing part, which contains abrasive grains, an oxidant, and a water-soluble polymer.

2. The polishing composition according to claim 1, wherein 5,000 or more molecules of the water-soluble polymer are adsorbed per 1 μm² of a surface area of the abrasive grains.

3. The polishing composition according to claim 1, wherein the water-soluble polymer has an amine value of 10 mg KOH/g or more.

4. The polishing composition according to claim 1, wherein the water-soluble polymer has hydrophilic groups, and the germanium material-containing part after the object to be polished has been polished by using the polishing composition has a water contact angle that is smaller than the water contact angle of the germanium material-containing part after the object to be polished has been polished by using another composition having a similar composition to that of the polishing composition except for the water-soluble polymer.

5. The polishing composition according to claim 1, wherein the water-soluble polymer is an anionic surfactant represented by the chemical formula: R1-X1-Y1 (wherein R1 represents an alkyl group, an alkylphenyl group or an alkenyl group, X1 represents a polyoxyethylene group, a polyoxypropylene group or a poly(oxyethylene-oxypropylene) group, and Y1 is represented by a SO₃M1 group, a SO₄M1 group, a CO₂M1 group or a PO₃M1₂ group (wherein M1 represents a counter ion)).

6. A polishing method, comprising polishing an object to be polished having a germanium material-containing part by using the polishing composition according to claim 1.

7. A method for producing a substrate having a germanium material-containing part, comprising a step of polishing by the polishing method according to claim 6.
